(19) United States
(12) Patent Application Publication
(10) Pub. No.: US 2015/0169525 A1
(43) Pub. Date: Jun. 18, 2015

(54) AUGMENTED REALITY IMAGE ANNOTATION

(71) Applicants: Leon Gomes Palm, Santa Monica, CA (US); Hartwig Adam, Marina del Rey, CA (US); Dmytro Kalenichenko, Los Angeles, CA (US)

(72) Inventors: Leon Gomes Palm, Santa Monica, CA (US); Hartwig Adam, Marina del Rey, CA (US); Dmytro Kalenichenko, Los Angeles, CA (US)

(21) Appl. No.: 13/619,457

(22) Filed: Sep. 14, 2012

(51) Int. Cl. G06F 17/24; G06F 17/30

(52) U.S. Cl. CPC G06F 17/241; G06F 17/30882

(57) ABSTRACT

A method and system for performing augmented reality processing generates annotation information for display on a device. An annotation request for an image is sent to an annotation service. The annotation service identifies elements in the image indicative of an individual and obtains user profile results for the individual. The user profile results are used to generate annotation information, which is presented for display on a device as an overlay to the image. The annotation information may include links to information that are selectable by a user of the device.

### BACKGROUND

The present disclosure relates to image processing and, more particularly, to overlaying annotations on images. Generally, Internet search results are provided in response to receiving either a text-based query, such as a query regarding the item of interest, or a non-text-based query, such as a query based on an image of the item of interest. Applications for processing a text-based query generally parse one or more key words from the query, conduct a search based on the identified key words, and return one or more search results that include links to applicable resources. Applications for processing image-based queries generally scan the image, identify certain elements within the image, conduct a search of the identified elements, and return one or more search results that include links to applicable resources.

### SUMMARY

Augmented reality processing refers to augmenting an image of a physically real environment or item with computer generated content. The processing can be performed live or in substantially real-time. In one aspect, images received from mobile devices are augmented in response to requests from mobile device users to receive augmentation of content within an image that is related to a particular context of the image and can further include leveraging features from existing social databases.

In one aspect, a disclosed method includes identifying a first contact identifier appearing in an image, captured by a mobile device, that is indicative of an individual. First user profile results associated with the first contact identifier are then obtained from one or more social databases. The method includes generating annotation information that includes user profile information derived from the first user profile results and providing the annotation information for presentation on the mobile device.

In some implementations, the method includes identifying a second contact identifier indicative of the individual and obtaining, from the social databases, second user profile results associated with the second contact identifier. The annotation information can include user profile information derived from the second user profile results. The second contact identifier can be used to select one or more of the first user profile results. The annotation information can include user profile information derived from the selected first user profile results.

In particular implementations, the annotation information includes overlay information to overlay the image. The first contact identifier can be image text, a facial image, an audio element associated with the image, and/or an optically detectable code. The first contact identifier and the second contact identifier can be different types of contact identifiers. The annotation information can include a link to a social network website page associated with the individual.

In another aspect, a mobile device includes a processor, a display device, a camera for generating image data corresponding to an image, and computer readable media accessible to the processor. The media includes processor executable program instructions to cause the processor to identify a first contact identifier appearing in the image, wherein the first contact identifier is indicative of an individual. First user profile results associated with the first contact identifier are then obtained from one or more social databases. Annotation information that includes at least a portion of user profile information derived from the first user profile results can be generated and provided for presentation on the mobile device.

In some implementations, the annotation information is superimposed on the image as an overlay. In other implementations, the annotation information is displayed separately from the image. The annotation information can include links to a social network website associated with the individual. In particular implementations, a second contact identifier indicative of the individual is identified and used to obtain, from the one or more social databases, second user profile results associated with the second contact identifier and generate annotation information that includes user profile information derived from the second user profile results. The processor can also identify a second contact identifier indicative of the individual and use the second contact identifier to select one or more of the first user profile results and to generate user profile information derived from the selected first user profile results.

In a further aspect, disclosed non-transitory computer readable media includes computer executable program instructions that can be executed by a processor to identify a first contact identifier appearing in an image captured by the mobile device, wherein the first contact identifier is indicative of an individual, to obtain, from one or more social databases, first user profile results associated with the first contact identifier, to generate annotation information that includes user profile information derived from the first user profile results, and to provide the annotation information for presentation on the mobile device.

The program instructions can cause the processor to identify a second contact identifier indicative of the individual, select one or more of the first user profile results based on the second contact identifier, and to generate user profile information derived from the selected first user profile results. The program instructions can cause the processor to format the annotation information in a markup language document format and render the annotation information for display with at least a portion of the image. In other implementations, the program instructions can cause the processor to receive user input indicating selection of an element in the annotation information and access content specified by the user input. The first contact identifier and the second contact identifier can be different types of contact identifiers.

In one aspect, a disclosed method includes detecting a contact identifier of an individual appearing in an image and querying a plurality of social databases for a match with the contact identifier. The method includes retrieving, from one or more of each social database returning a first match, user profile information for the individual, preparing annotation information from the user profile information, and annotating the image with the annotation information.

In some implementations, the contact identifier can be selected from text depicted in the image, a facial image, and/or an optically detectable code. The image can comprise a frame of multimedia content. The user profile information can include an additional contact identifier for the individual and the method can include querying a social database from the plurality of social databases for a second match with the additional contact identifier. Responsive to receiving multiple first matches, the method includes filtering the multiple first matches using the additional contact identifier. Detecting the contact identifier can include obtaining a second contact identifier based on recognition of a first contact identifier in the image. The first contact identifier and the second contact identifier can be different types of contact identifiers. The annotation information can include a link to a user account on a social database website.

In another aspect, a mobile device for providing augmented reality services includes a processor configured to access memory media, a display device, and a camera for generating image data corresponding to an image. The memory media can include processor executable instructions to detect a contact identifier from the image data. The contact identifier can be indicative of a specific individual. Based on a match between the contact identifier and an entry in a social database, the instructions can retrieve user profile information describing the specific individual from the social database and annotate the image on the display device with an annotation, wherein the annotation includes at least a portion of the user profile information.

In some implementations, annotating includes overlaying the annotation on the image and/or displaying the annotation separately from the image. The annotation can include links to social database servers available to a user of the mobile device. The user profile information can include additional contact identifiers for the specific individual.

In a further aspect, disclosed non-transitory computer readable memory media includes application program instructions for providing augmented reality services. The application program can be executed to receive an image annotation request specifying an image captured by a camera or other form of photographic device and to identify a contact identifier in the image. The contact identifier can be associated with an individual and can include an identifier, such as text generated by optical character recognition, a facial pattern identifier, and/or an optically scannable or detectable code. Based on a match between the contact identifier and an entry in a social database, the instructions can be executed to retrieve user profile information describing the individual from the social database and to generate an annotation associated with the image. The annotation can include at least a portion of the user profile information.

In particular implementations, generating the annotation includes formatting the annotation in a markup language document format and rendering the annotation for display with at least a portion of the image. The application program can receive user input indicating selection of an element in the annotation and can retrieve content specified by the user input. The annotation can include a link to a user account on a social network website. The user profile information can include information retrieved from a plurality of social database servers corresponding to different respective social network websites.

In yet another aspect, a disclosed method includes receiving an image annotation request indicating an image, identifying elements of the image, and detecting one or more ensembles, also referred to herein simply as ensembles, in the identified elements. An ensemble includes a group of elements that share one or more attributes. The elements of the image can include pattern elements, scene elements, object elements, landscape elements, architectural elements, text elements, which can be generated by optical character recognition, or location elements.

The method can include filtering, ranking, or otherwise evaluating two or more detected ensembles according to a defined set of criteria to identify a selected ensemble. An annotation schema indicative of types of annotation information suitable for annotating to the image can then be identified for the selected ensemble. The method can further include retrieving annotation information applicable to the selected ensemble and generating an annotation associating the annotation information with the selected ensemble.

The criteria for evaluating the ensembles includes, as examples, the number of elements in an ensemble, the types of elements in an ensemble, the commercial relevance of elements included in an ensemble, and/or user preferences for weighting elements included in an ensemble. The ensembles can be ranked according to the defined set of criteria and the selected ensemble can be chosen based upon the rankings.

The image annotation request can be received from a mobile device and the annotation information for a selected ensemble can be sent to the mobile device for rendering. The image annotation request can also be received from an image server and the annotation information for the ensemble can be sent to the image server. The method operation of retrieving the annotation information includes retrieving content specified by the selected ensemble.

In still another aspect, a disclosed mobile device for providing augmented reality services includes a processor configured to access memory media, a display device, and a camera for generating image data. The memory media includes processor executable application program instructions to detect ensembles from image data generated by the camera. The application program can filter detected ensembles according to a defined set of criteria to identify a selected ensemble. The application program can then determine an annotation schema indicative of types of annotation information suitable for annotating to the image data. The application program can generate annotation information applicable to the selected ensemble based on the annotation schema and render an annotation on the display device, wherein the annotation associates the annotation information with the selected ensemble.

In yet another aspect, disclosed computer readable memory media include application program instructions that implement an application program for providing augmented reality services. The application program, when executed, can receive an image annotation request for an image captured by a photographic device and identify elements from the image. The application program can detect ensembles from the identified elements and filter the ensembles according to a defined set of criteria to identify a selected ensemble. The application program can also determine an annotation schema indicative of types of annotation information suitable for annotating to the image and can generate an annotation associating annotation information with the selected ensemble.

In some implementations, the application program receives user input associated with the annotation and retrieves content specified by the user input. The application program can process an indication of the selected ensemble under an association with a device.

Advantages of the image annotation system described herein include identifying user contact information for an individual associated with an image, accessing information pertaining to the individual in one or more social databases, presenting the information for annotation with the image, and permitting a user to establish one or more social database connections with the individual in a live or substantially real-time manner. Other advantages include detecting ensembles from elements identified in an image and presenting annotation information as an overlay on the image for a selected ensemble in a live or substantially real-time manner.

### BRIEF DESCRIPTION OF THE DRAWINGS

FIG. 1 is a block diagram of selected elements of an implementation of an augmented reality processing system;

FIG. 2 illustrates selected elements of an implementation of an annotated image;

FIG. 3 depicts selected elements of an implementation of a method for performing image annotation;

FIG. 4 is a block diagram of selected elements of an implementation of an augmented reality process;

FIG. 5 is a block diagram of selected elements of an implementation of a search system that includes a server for performing image annotation;

FIG. 6 is a block diagram of selected elements of an implementation of a mobile device for performing image annotation;

FIG. 7 depicts selected elements of an implementation of a method for performing image annotation; and

FIG. 8 is a block diagram of selected elements of an implementation of an augmented reality process.

### DETAILED DESCRIPTION

In the following description, details are set forth by way of example to facilitate discussion of the disclosed subject matter. It should be apparent that the disclosed implementations are examples and are not exhaustive of all possible implementations.

Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

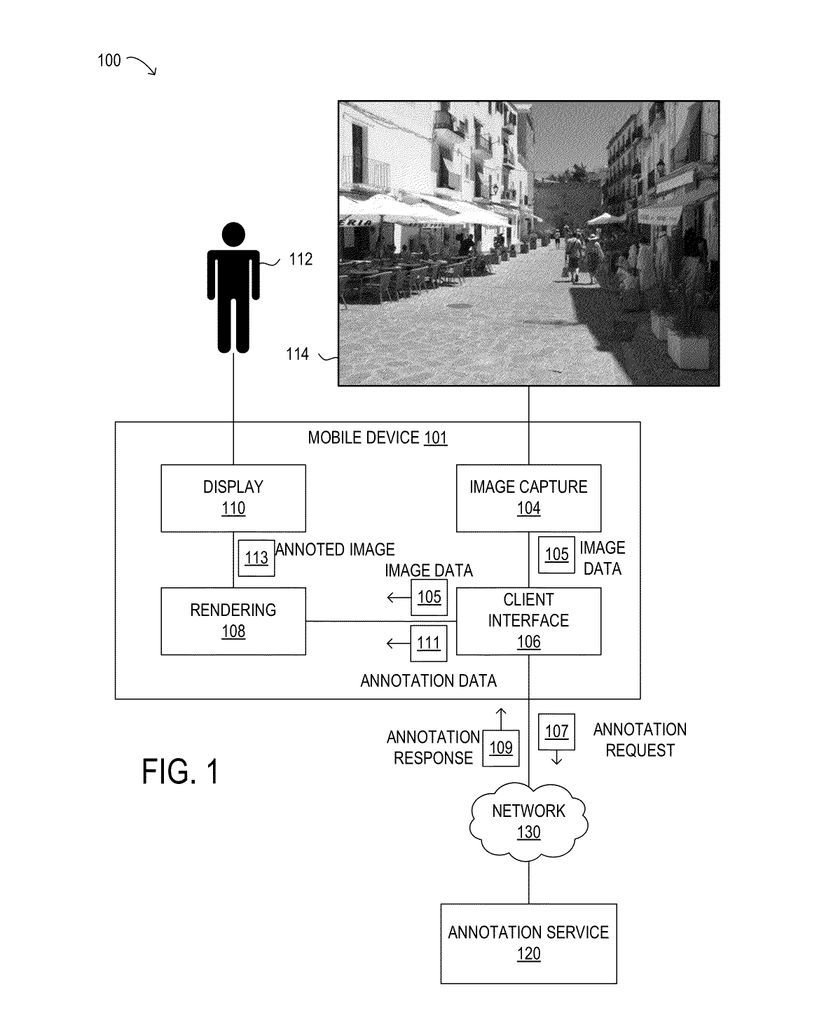

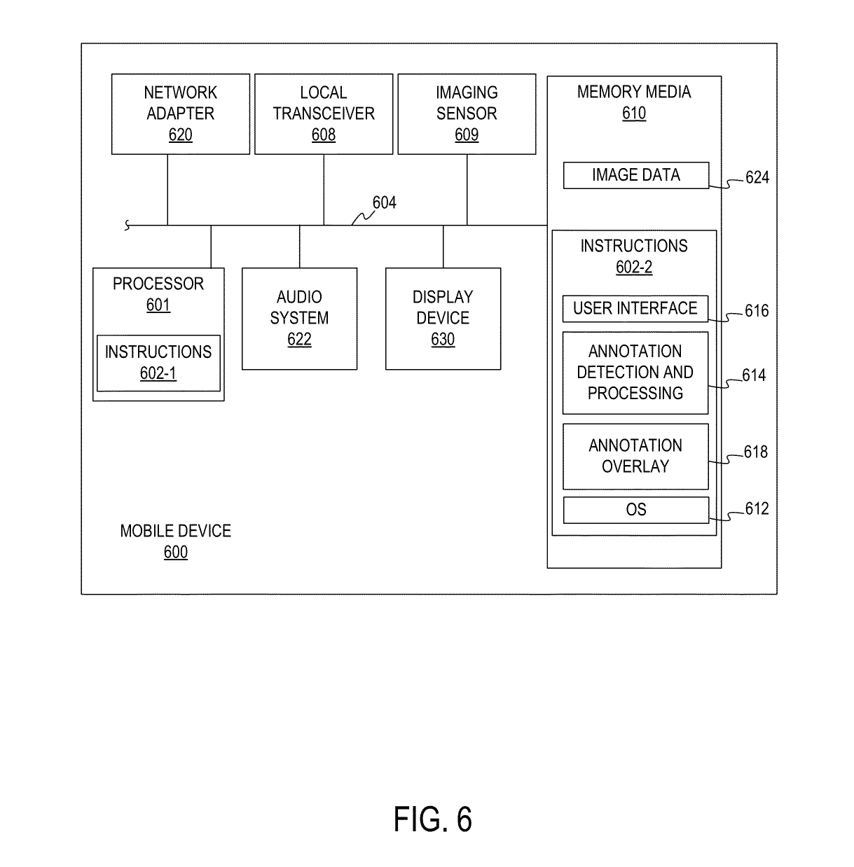

Referring now to FIG. 1, a block diagram of selected elements of an implementation of an augmented reality processing system 100 employing features for performing image annotation is depicted. FIG. 1 depicts a user 112 who owns, operates, or is otherwise associated with a mobile device 101. Mobile device 101 represents any of a variety of mobile devices used for communication, networking, multimedia presentation, and various other applications. In some implementations, mobile device 101 represents a smart phone owned or used by user 112. The elements of mobile device 101 depicted in FIG. 1 represent elements of mobile device 101 suitable for capturing an image, augmenting the image with an annotation, and displaying the annotated image. Data processing system architectural aspects of mobile device 101 are depicted and described with respect to FIG. 6.

Mobile device 101 as depicted in FIG. 1 includes an image capture feature 104 that implements a digital camera or other imaging device. Image capture feature 104 captures image 114 and generates image data 105 that corresponds to or is otherwise indicative of image 114. FIG. 1 depicts a client interface 106 of mobile device 101 sending an annotation request 107 to an annotation service 120 using network 130. Annotation request 107 can include a copy of, a link to, or another form of indication of image data 105. Although FIG. 1 depicts annotation service 120 remotely located from mobile device 101, annotation service 120 can, in other implementations, be included within mobile device 101 and can be directly accessible, for example, in place of client interface 106.

Annotation service 120 receives annotation request 107 and performs augmented reality processing on the image data indicated by annotation request 107. Annotation service 120 then sends an annotation response 109 including annotation data 111 for annotating image data 105, to client interface 106 of mobile device 101. Client interface 106 then extracts or otherwise accesses annotation data 111 from annotation response 109 and sends the annotation data 111, together with image data 105, to image rendering feature 108. Image rendering feature 108 processes image data 105 and annotation data 111 to create display data suitable for presentation to the user through display 110. Image rendering feature 108 can, for example, overlay an image corresponding to image data 105 with an annotation indicated by annotation data 111 and generate annotated image 113 in a format suitable for presentation on display 110. Display 110 then displays annotated image 113 to user 112. The annotation data 111 can be represented as an annotation to image data 105 that enables the user to select and to query additional information, as desired.

The annotation itself can include information about the image or elements of the image. If, for example, the image depicts a group of elements that share a set of characteristics, the annotation can provide additional information with respect to each element in the group. For example, if an image depicts five different makes and models of automobiles, the annotation can indicate the manufacturer suggested retail price, user rating, and closest dealership information with respect to each of the five cars depicted in the image. Annotation information can be located or arranged within the image to coincide with the image element to which it pertains and can include active links corresponding to each element of the ensemble.

The annotation can also enhance or supplement information contained in the original image. For example, if an image depicts, identifies, or otherwise indicates an individual, the annotation can include additional information about the individual. The annotation service can include a social database feature that detects, in an image, information identifying an individual. This identifying information is also referred to herein as a contact identifier. The contact identifier can be text-based, e.g., a person's name indicated on an image of a business card or driver's license, pattern-based, e.g., an image of a person's face, or data-based, e.g., an image of a bar code encoded with identifying information. The annotation service can invoke the social interface feature to query one or more social networks, telephone directories, call lists, address books, or other publicly or privately available databases or network resources containing contact or user profile information for individuals, referred to herein as a “social database” or “social databases”, for a match with the individual depicted or otherwise represented in an image. User profile information can be retrieved for the individual from social databases, including applicable servers and websites. The profile information can be used to annotate the image. If, for example, an image indicates an individual who has a profile on SocialNet.com, the annotation can include a selectable element corresponding to the individual's SocialNet.com profile. The selectable element could be positioned on or near the portion of the image identifying the individual. The selectable element can include, as an example, a link to the individual's SocialNet.com profile, a link to a SocialNet.com resource for initiating a contact with the individual, or both.

As described above, an annotation service can include an ensemble detection feature for detecting ensembles of elements appearing in an image and augmenting the image with an annotation that provides additional information about or pertaining to the elements of the ensemble.

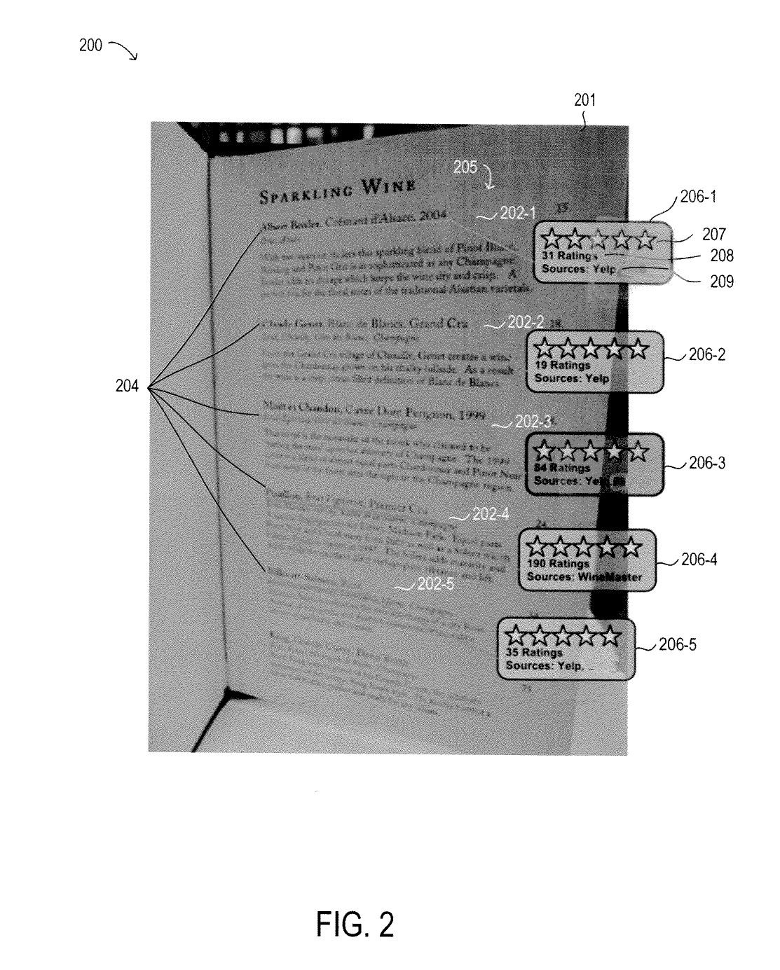

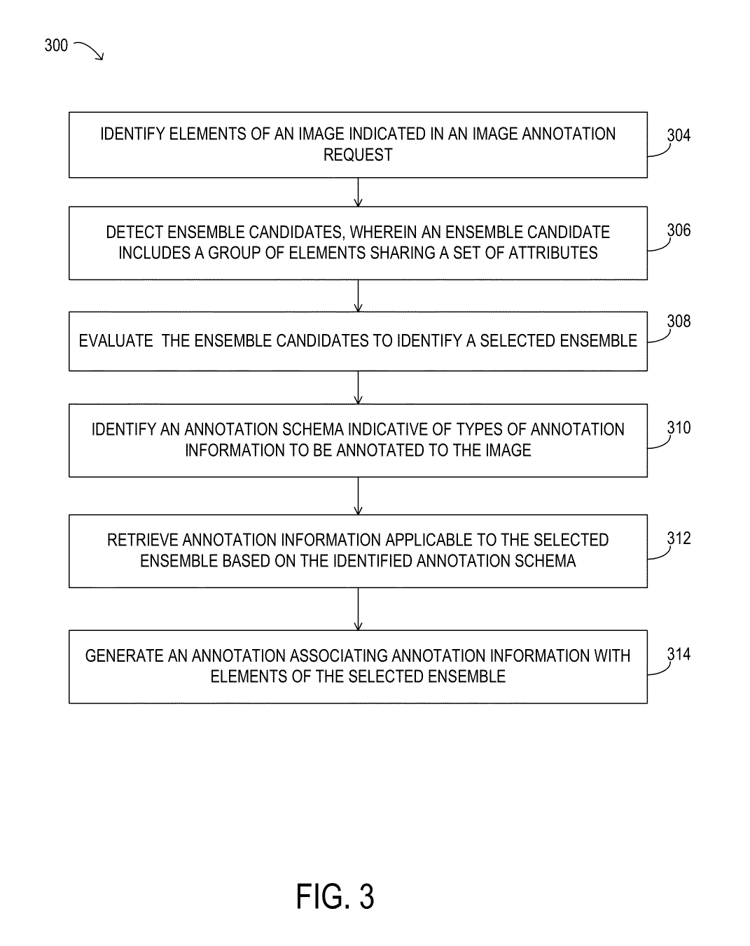

Turning now to FIG. 2, selected elements of an implementation of annotated image 200 generated by an annotation service invoking an ensemble detection feature are illustrated. Annotated image 200 represents an example of an annotated image 113 depicted in FIG. 1. Annotated image 200 can also represent an image annotation generated according to image annotation method 300 as described with respect to FIG. 3 to provide annotations for an ensemble.

In FIG. 2, annotated image 200 includes an underlying image 201 and an annotation 204. As depicted in FIG. 2, image 201 is an image of a wine list or wine menu and annotation 204 is a group of graphical elements overlaying image 201. Image 201 as shown in FIG. 2 includes five wine list entries 202-1 through 202-5. Each wine list entry 202 shares a common set of characteristics. For example, each wine list entry 202 includes a winery name in bold text, followed by a wine name, followed by a year, followed by a price, which is right justified and indicated as an integer without a “$” symbol or any decimal point.

If an image annotation request 107 (FIG. 1) identifying image 201 were provided to annotation service 120 (FIG. 1), annotation service 120 can determine that the collection of wine list entries 202-1 through 202-5 constitute an ensemble 205 and annotation service 120 can then generate annotation 204 corresponding to ensemble 205. As depicted in FIG. 2, annotation 204 includes a set of annotation elements 206-1 through 206-5 where each annotation element 206 corresponds to a wine list entry 202 of ensemble 205. In this example, the elements that annotation service 120 groups into ensemble 205 are the wine list entries 202.

Image 201 may, however, have other elements and other groups of elements that might constitute ensembles. For example, each character of text depicted in image 201 may constitute an element of image 201 and any two or more characters may constitute an ensemble candidate. Similarly, image 201 depicts words as well as characters and each word might constitute an element of image 201. In the case of characters, each character may have attributes such as language/alphabet, case, script, and so forth. Similarly, each word may have attributes such as part of speech, language, number of characters, number of syllables, and so forth. Annotation service 120 can evaluate multiple different elements and groups of elements to identify various candidate ensembles.

Annotation service 120 can identify the elements of image 201 using optical character recognition, pattern detection, and any other suitable image processing technique. Image 201 as shown in FIG. 2 consists substantially entirely of text so that optical character recognition can be a primary image processing technique employed by annotation service 120 for image 201. Image 201 nevertheless includes a formatting or structure that can lend itself to pattern recognition techniques so that, as an example, annotation service 120 can detect the pattern of headings and textual descriptions for each of five wine list entries 202 on the menu and annotation service 120 can then propose or otherwise consider ensemble candidates based on the physical or visual arrangement of the elements and, perhaps more significantly, patterns or other elements that might share characteristics common to a group of visually similar elements.

Using such a technique might, for example, accelerate the ensemble detection process by considering larger and more complex elements of image 201 earlier in the process. Thus, rather than consider each character, each word or each sentence of image 201 can be considered until a set of elements are detected that share a set of attributes. In some implementations, the commercial relevance of the elements is considered. Generally, the attributes of elements that are identified as products or services are considered to be more commercially relevant than attributes of other elements. For example, although individual characters of a text-based image might constitute individual elements of the image, the attributes that individual characters share, e.g., case: [upper/lower], may not have tremendous commercial significance. Attributes or elements in the image that are products or services, however, may have significant commercial significance. Annotation service 120 as depicted in FIG. 2 has identified and chosen the group of five wine list entries 202-1 to 202-5 as the ensemble 205 to be annotated. In this example, each wine list entry 202 shares a common set of one or more attributes. In other implementations, following identification of the applicable elements in image 201, annotation service 120 conducts one or more searches of the Internet or other publicly or privately available networks to generate knowledge data for which one or more attributes such as price, age, geographic location, review or rating information, etc. can be identified for each of the elements. The identified attributes for each of the elements are then compared in order to identify those elements that have a quantity of common attributes that match or exceed a predetermined criteria, with the qualifying elements being potential ensemble candidates. The attributes of an image element can be specified in terms of name-value pairs (NVPs) or another suitable open-ended data structure.

The domain of NVPs that may be associated with an image element can be open ended or can be limited to a predetermined set. Moreover, the domain of available NVPs may depend on the type of element. To illustrate, if the element is a single character, the domain of NVPs may include a character-type NVP that would be inapplicable to other types of elements, e.g. <character_type:numeral>. Similarly, if the element is a word, the NVP domain may include a word-type NVP, e.g., <word_type:noun>, and, if the element is itself a picture or pattern, an entirely different NVP domain may apply based upon the discerned object in the picture or pattern, e.g., <object_type:wine bottle>. On the other hand, some attributes may be applicable to multiple types of elements or all elements, e.g., <element_type:value>. The domain of recognized element types and the domain of NVPs associated with each recognized element type are implementation details and can change from implementation to implementation and can also change with time.

Regardless of what types of elements annotation service 120 is capable of recognizing and what attributes annotation service 120 might assign to an element, most images of any appreciable complexity, including image 201, may include multiple types of elements and multiple instances of any given element type. Any group of two or more elements of the same type, e.g., elements that share an element-type attribute, can constitute an ensemble candidate. Image 201 as depicted in FIG. 2 can include, as examples, a winery name ensemble, consisting of the set of five words or phrases that have an object-type attribute equal to “winery”, a price ensemble, consisting of the set of 5 numerals indicating price, and so forth.

When an image contains multiple ensemble candidates, annotation service 120 can select one of the ensemble candidates as the ensemble selected for annotation. The selection of an ensemble for annotation can be based on various factors and criteria. Annotation service 120 can, for example, impose a minimum and/or maximum number of elements criteria. If the number of elements in an ensemble candidate is lower than the minimum or greater than the maximum, the candidate would be discarded.

The ensemble selection process can include evaluating the candidate ensembles and selecting the ensemble candidate having the greatest perceived value. The valuation of any given ensemble can depend on the purpose for which the annotation is being considered. If an annotation indicates an objective characteristic such as the age of each element in an ensemble candidate, ensemble candidates whose constituent elements have no age would be discarded.

When an annotation is intended to provide information that may be of commercial value, the candidates can be evaluated in terms of a commercial relevance. In some implementations, commercial value refers to the value or potential value of the information to a consumer or potential consumer of an item associated with the information. For example, annotation service 120 can identify, in image 201 as shown in FIG. 2, two ensemble candidates, namely, a winery ensemble candidate consisting of the five words or word phrases indicating a winery and a wine name ensemble candidate consisting of the five words or phrases that indicate the name of a wine.

Annotation service 120 can select between these two candidates based, at least in part, on the perceived value of annotating the wineries or annotating the wine names. This valuation can be influenced by which ensemble candidate represents products or services available for purchase for which a consumer is more likely to want to request an annotation. In other implementations, this valuation is influenced by which ensemble candidate has the greatest number of attributes. In this manner, annotation service 120 may conclude that the wine name ensemble candidate is a product and is perceived as having a higher commercial relevance than the winery name ensemble candidate.

After selecting one of the ensembles, annotation service 120 identifies an annotation schema that indicates what type of information the annotation will provide and then initiates one or more searches for the information indicated by the identified schema. When annotation service 120 has received or otherwise has access to the desired information, annotation service 120 generates the annotation. The annotation schema can include, indicate, or otherwise be associated with an annotation template and generating the annotation can include populating the template with the annotation information.

As evident from annotation 204 of FIG. 2, the annotation elements 206 corresponding to the annotation schema identified for ensemble 205 include three pieces of annotation information for each element of ensemble 205, e.g., each wine list entry 202. As depicted in FIG. 2, annotation elements 206 include a star-rating graphic 207, a sample-size indication 208, and ratings source indicator 209. Based on the identified annotation schema, annotation service 120 obtains star-rating information and the corresponding sample size and ratings source information for each wine list entry 202 in ensemble 205 and provides this information within annotation response 109 to client interface 106. Client interface 106, in conjunction with image rendering feature 108, generates annotated image 113 of FIG. 1, which is then displayed as annotated image 200 in FIG. 2. Thus, annotated image 200 includes annotation elements 206-1, 206-2, 206-3, 206-4, and 206-5 to provide a common set of information for each wine list entry 202 of ensemble 205.

Turning now to FIG. 3, selected elements of an implementation of method 300 for performing image annotation are illustrated. Method 300 describes image annotation by ensemble detection and processing. In one implementation, method 300 is performed by annotation service 120 (see FIG. 1). It is noted that certain operations described in method 300 can be optional or can be rearranged in different implementations.

In one implementation, method 300 begins by identifying (operation 304) elements of an image indicated in an image annotation request. The elements of the image can include text that may be generated by optical character recognition or recognition of one of a pattern, a scene, an object, a landscape, an architectural element, a business, a product, a brand, and a location within the image. The image annotation request may have been originated by a user of a mobile device that captured the image. Method 300 further includes detecting (operation 306) ensemble candidates wherein an ensemble candidate includes a group of image elements that share one or more attributes. Detecting ensemble candidates may include identifying image elements, determining attributes associated with the identified image elements, and grouping the identified elements into groups where all of the elements in a group share at least some attributes. These groups constitute ensemble candidates.

The ensemble candidates can be evaluated (operation 308) to identify a selected ensemble. Ensemble candidates can be evaluated based on various factors including, as examples, the number and/or types of elements in the ensemble candidate, a commercial relevance of the elements, user preferences for weighting the elements, or a combination thereof. After selecting an ensemble for annotation, annotation schema are identified (operation 310). The annotation schema determines what type of information will be retrieved. For example, referring to FIG. 2, annotation schema determined that annotation element 206 would include star-rating graphic 207, sample-size indication 208, and ratings source indicator 209. The annotation schema can be identified from predetermined templates associated with applicable element classes such as consumer products, restaurants, services, real estate, travel destinations, and the like or may be user selectable from a list of available information types.

Based on the identified annotation schema, annotation service 120 retrieves annotation information pertaining to each of the elements of the selected ensemble (operation 312). An annotation such as annotation 204 (FIG. 2) is then generated (operation 314). Generating the annotation can include generating and arranging annotation elements 206 and overlaying or otherwise integrating the annotation elements with the applicable image. The annotation can include, in addition to annotation elements, graphic elements indicating, for example, which annotation elements correspond to which elements of the image. In the implementation depicted in FIG. 1, mobile device 101 generates the annotation and renders the annotation together with the image. In other implementations, annotation generation can be performed partially or entirely by a remotely located server such as annotation service 120. Annotation generation can include, for example, generating an annotation as a graphic for overlaying on the image with annotation information corresponding to each element of the selected ensemble positioned near the corresponding element. Depending upon the implementation and the type of information provided in an annotation, the annotation can include links to other network resources or service providers. In these implementations, when input indicating user selection of such a link is received, content corresponding to the user input is retrieved and presented to the user. For example, if an annotation includes a link to a web page and the link is clicked or otherwise selected by a user, content corresponding to the web page can be retrieved and presented to the user. In some implementations, an indication of which ensemble was selected can be associated with a device.

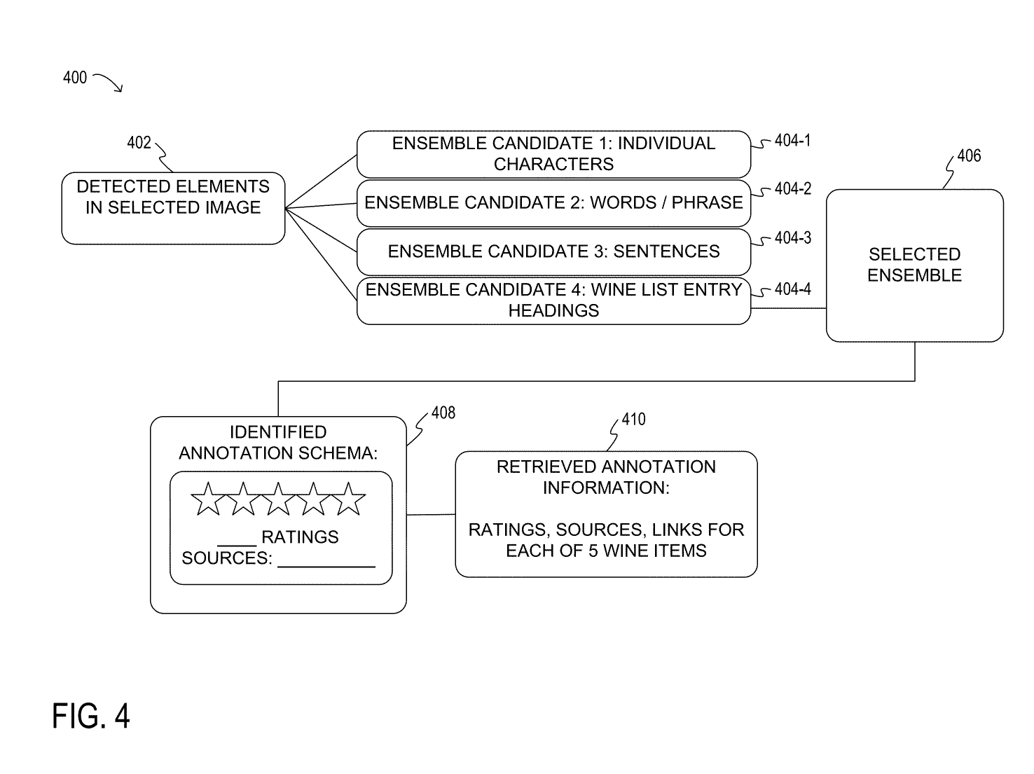

Referring now to FIG. 4, a block diagram illustrating selected elements of an implementation of augmented reality process 400 is presented. Augmented reality process 400 is shown as an example to illustrate how method 300 can be performed to generate annotated image 200 (see FIGS. 2 and 3). It is noted that certain operations described in augmented reality process 400 can be optional or can be rearranged in different implementations.

Augmented reality process 400 as shown in FIG. 4 depicts the set of elements 402 annotation service 120 detects in an image and a set of ensemble candidates 404-1 through 404-4 that annotation service 120 identifies:
ensemble candidate 1 404-1: individual characters in image 201;
ensemble candidate 2 404-2: words and phrases in image 201;
ensemble candidate 3 404-3: sentences in image 201; and
ensemble candidate 4 404-4: wine list entry headings 202 in image 201.

FIG. 4 represents the ensemble selected for annotation as selected ensemble 406. Augmented reality process 400 further represents an annotation schema 408 that has been identified for use with the selected ensemble and the annotation information 410, which is compliant with the identified annotation schema 408 and applicable to the elements of the selected ensemble 406.

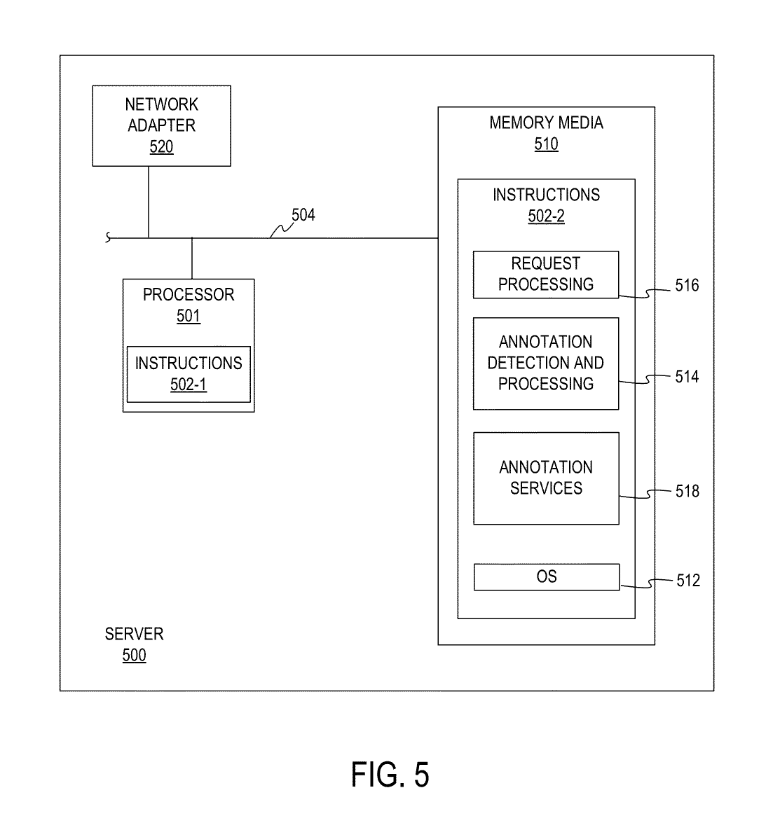

Referring now to FIG. 5, a block diagram illustrating selected elements of an implementation of server 500 is presented. Server 500 can represent an implementation of annotation service 120 (see FIG. 1) and/or another server. As shown in FIG. 5, server 500 operates in conjunction with mobile device 101 (see FIG. 1) to execute the methods and operations described herein.

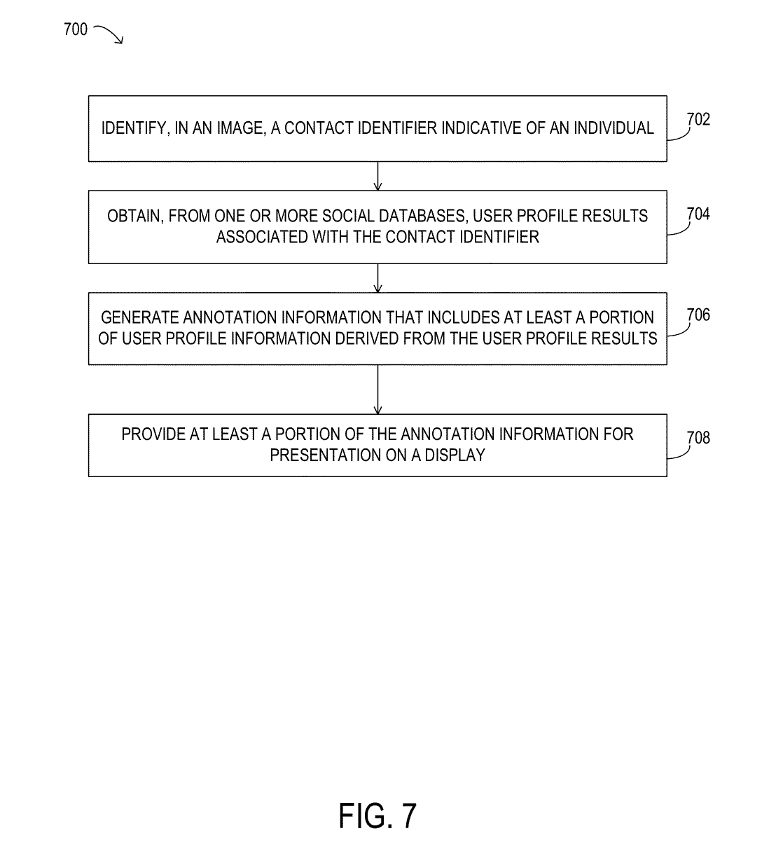

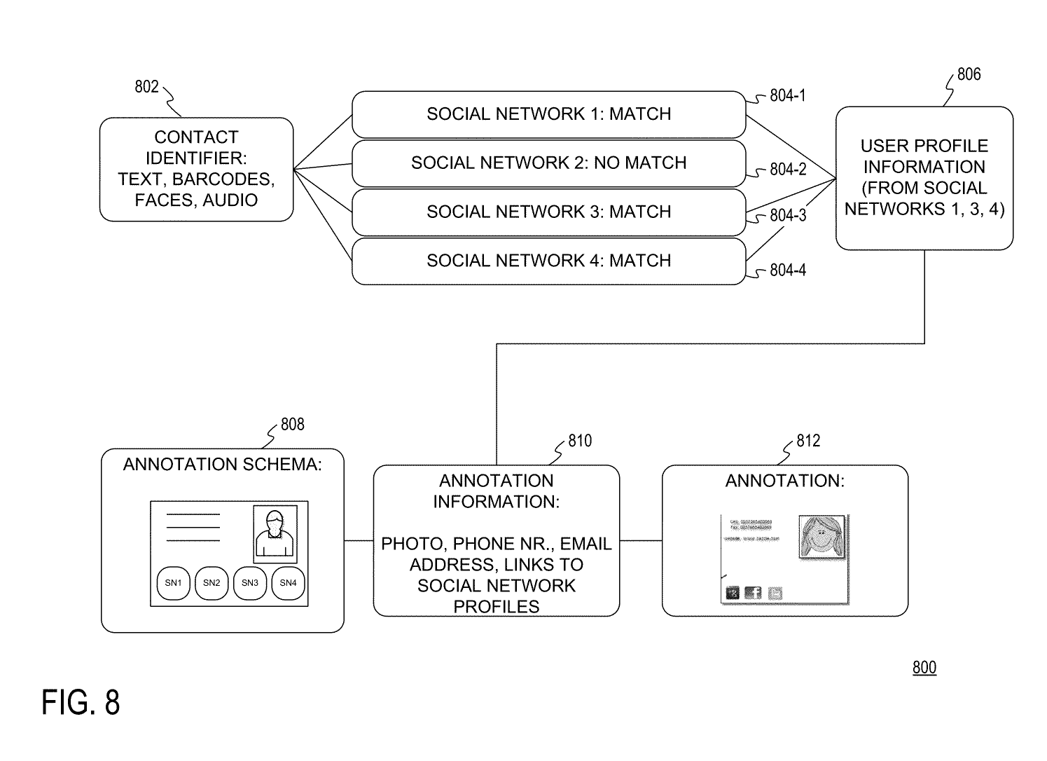

In the implementation depicted in FIG. 5, server 500 includes processor 501 coupled through shared bus 504 to storage media collectively identified as memory media 510. Server 500, as depicted in FIG. 5, further includes network adapter 520 that interfaces server 500 to a network (not shown in FIG. 5), such as a wide-area network and/or a wireless network system. In FIG. 5, memory media 510 can encompass persistent and volatile media, fixed and removable media, and magnetic and semiconductor media. Memory media 510 is operable to store instructions, data, or both. Memory media 510 as shown includes sets or sequences of instructions 502-2, namely, an operating system 512, annotation services 518, annotation detection and processing 514, and request processing 516. Operating system 512 can be any suitable operating system. Instructions 502 can also reside, completely or at least partially, within processor 501 during execution thereof. It is further noted that processor 501 can be configured to receive instructions 502-1 from instructions 502-2 through shared bus 504. Annotation services 518 can represent an implementation of annotation service 120 (see FIG. 1). Request processing 516 represents a module to receive and respond to requests for image annotation, as described herein. Annotation detection and processing 514 represents processing modules for performing image analysis and annotation processing, as described herein. For example, annotation detection and processing 514 can include specialized algorithms for detecting and processing ensembles of elements in images (see FIGS. 2-4) and/or for social interfacing (see FIGS. 7-8).

Referring now to FIG. 6, a block diagram illustrating selected elements of an implementation of mobile device 600 is presented. Mobile device 600 can represent an implementation of mobile device 101 (see FIG. 1) and/or another mobile device configured for augmented reality processing, as described herein. As shown in FIG. 6, mobile device 600 operates in conjunction with server 500 (see FIG. 5) to execute the methods and operations described herein.

In the implementation depicted in FIG. 6, mobile device 600 includes processor 601 coupled through shared bus 604 to storage media collectively identified as memory media 610. Mobile device 600, as depicted in FIG. 6, further includes network adapter 620 that interfaces mobile device 600 to a network (not shown in FIG. 6), such as a wireless network. In FIG. 6, memory media 610 encompasses persistent and volatile media, fixed and removable media, and magnetic and semiconductor media. Memory media 610 is operable to store instructions, data, or both. Memory media 610 as shown includes sets or sequences of instructions 602-2, namely, an operating system 612, annotation overlay 618, annotation detection and processing 614, and user interface 616, as well as image data 624. Operating system 612 can be any suitable operating system. Instructions 602 can also reside, completely or at least partially, within processor 601 during execution thereof. It is further noted that processor 601 can be configured to receive instructions 602-1 from instructions 602-2 through shared bus 604. Annotation overlay 618 performs rendering and preparation of annotations for presentation on display device 630 (see also FIG. 1, rendering 108). Annotation detection and processing 614 represents similar functionality as annotation detection and processing 514 (see FIG. 5) that is performed by processor 601. User interface 616 represents user interface instructions for operating mobile device 600, and can be integrated with operating system 612.

In various implementations, mobile device 600, as depicted in FIG. 6, includes local transceiver 608, which provides connectivity for local-area or personal networks. Imaging sensor 609 represents a device for acquiring images, such as a video camera and/or a digital camera, which can generate image data 624. Other devices included with mobile device 600 include audio system 622, which can provide audio input/output and support audio devices, such as headphones, microphones, speakers, etc. and represents a device included with mobile device 600 for providing signals or indications to a user, such as loudspeakers for generating audio signals.

Mobile device 600 is shown in FIG. 6 including a display device or, more simply, display 630, which can interface a display adapter (not shown) through shared bus 604. Display 630 can be implemented as a liquid crystal display screen, a monitor, a television or the like. Display 630 can comply with a display standard for computer monitors and/or television displays. Standards for computer monitors include analog standards such as video graphics array (VGA), extended graphics array (XGA), etc., or digital standards such as digital visual interface (DVI) and high-definition multimedia interface (HDMI), among others. Display device 630 can include an integrated input device, such as a touch-screen, for manual operation of mobile device 600 by a user. Mobile device 600, in various implementations, further includes additional control elements, such as buttons, switches, power sources, and various connectors, which are omitted from FIG. 6 for descriptive clarity.

Turning now to FIG. 7, an implementation of method 700 for performing image annotation is illustrated. Method 700 describes image annotation by a social database interface. In one implementation, method 700 is performed by annotation service 120 (see FIG. 1). It is noted that certain operations described in method 700 can be optional or can be rearranged in different implementations.

Method 700 begins by identifying (operation 702) a contact identifier in an image that is indicative of an individual. The contact identifier (not shown) can be text depicted in the image, a facial image, an audio element associated with the image, and/or an optically detectable code. One example of a text that is a contact identifier is an email address. The individual himself or herself may not appear in the image, even though a contact identifier for the individual is detected from the image. In some implementations, the contact identifier can be gleaned from an image present in video content or from multimedia content, such as from an audio element or through text-to-speech processing of a voice utterance. User profile results associated with the contact identifier are obtained from one or more social databases (operation 704). The social databases can include social networks or social networking websites, as well as available address books, telephone directories, or other forms of user contact databases. Annotation information is generated (operation 706) that includes at least a portion of user profile information derived from the user profile results. The user profile information can include private information of the individual.

A second contact identifier indicative of the individual can be identified and can be used to disambiguate the user profile results associated with the initial contact identifier, such as by filtering or eliminating user profile results that are associated with the initial contact identifier, but not associated with the second contact identifier. Different types of contact identifiers can be used to filter or query different social databases. For example, image text and a facial image may be used to filter user profile results. The user profile information can be retrieved and stored as a compilation for the individual. Duplicate entries in the user profile information can be recognized as being redundant and can be removed. User profile results associated with the second contact identifier can also be obtained from the social databases and the annotation information can include user profile information derived from the user profile results associated with the second contact identifier. The first contact identifier and the second contact identifier can be different types of contact identifiers. The second contact identifier can appear in the image, the first user profile results, or both. In this manner, various portions of user profile information for the individual can be retrieved and analyzed.

Next in method 700, annotation information is provided for display on a device (operation 708). At least a portion of the user profile information is included in the annotation information. The device can include a computer and/or a mobile device such as a smart phone or tablet. In some implementations, an annotation schema can be used to define which information is included in the annotation information. The annotation information can be determined by user-defined settings and/or parameters associated with performing method 700. Then, the image can be annotated (not depicted) with the annotation information. In some implementations, annotation of the image includes superimposing the annotation information on the image as an overlay. The annotation information can include a link for the individual to a social network website page associated with the individual. Thus, a user can perform method 700 for enhanced social networking using augmented reality with annotated images.

Referring now to FIG. 8, a block diagram illustrating selected elements of an implementation of augmented reality process 800 is presented. Augmented reality process 800 is shown as an example to illustrate how method 700 can be performed to generate an annotated image (not shown). It is noted that certain operations described in augmented reality process 800 can be optional or can be rearranged in different implementations.

In augmented reality process 800, contact identifier(s) 802 can be detected from an image. The contact identifiers can be recognized as a logical data element that includes information for an individual. Then, various social databases can be queried for a match with the contact identifier. As shown in FIG. 8, four social databases have been queried with contact identifier 802:
social database 1: match 804-1;
social database 2: no match 804-2;
social database 3: match 804-3; and
social database 4: match 804-4.

Then, user profile information 806 is collected from social databases 1, 3, and 4. Optionally, annotation schema 808 can be retrieved for presentation and formatting of annotation information 810, which is generated from user profile information 806. The resulting annotation 812 can be overlaid on an image or can be displayed separately from an image. Annotation 812 can include links to social database user profiles for the individual and/or links to social database servers available to a user of the mobile device.

To the maximum extent allowed by law, the scope of the present disclosure is to be determined by the broadest permissible interpretation of the following claims and their equivalents, and shall not be restricted or limited to the specific implementations described in the foregoing detailed description.

1. A method, comprising:
identifying a first contact identifier displayed in an image captured by a mobile device, wherein the first contact identifier is indicative of an individual;
providing, to a plurality of social databases including user profile data for a plurality of social networks, respective requests that include the first contact identifier, wherein each request is a query for a user profile associated with the first contact identifier on a social network in the plurality of social networks;
receiving, from a first social database in the plurality of social databases, first user information included in a first user profile identified by the first contact identifier on a first social network;
receiving, from a second social database different from the first social database in the plurality of social databases, second user information included in a second user profile identified by the first contact identifier on a second social network, wherein the second user information differs from the first user information;
generating annotation information by combining the first user information and the second user information; and
providing the annotation information for presentation on the mobile device according to an annotation schema, wherein the annotation schema identifies formatting of annotation information, and wherein the provided annotation information includes references to the first social database and the second social database.

2. The method of claim 1, wherein the first contact identifier comprises one of an image text, a facial image, or an optically detectable code.

3. The method of claim 1, wherein providing the annotation information comprises:
providing the annotation information as an overlay of the image.

4. The method of claim 1, further comprising:
obtaining a second contact identifier indicative of the individual;
providing, to the plurality of social databases, respective requests that include the second contact identifier, wherein each request is a query for a user profile associated with the second contact identifier; and
receiving, from at least one of the social databases, responses that identify second user profiles.

5. The method of claim 4, further comprising:
filtering one or more of the first user profiles that are associated with a different individual than the second user profiles.

6. The method of claim 4, wherein the second contact identifier comprises a contact identifier displayed in the image or a contact identifier obtained from the first user profiles.

7. The method of claim 4, wherein the first contact identifier and the second contact identifier are different types of contact identifiers.

8. The method of claim 1, wherein each reference to a social database included in the annotation information is a link to a respective user profile of a social network associated with the social database.

9. A mobile device, comprising:
one or more processors;
a display device;
a camera for generating image data corresponding to an image; and
computer readable media accessible to the one or more processors, storing processor executable program instructions, the program instructions including instructions executable to cause the one or more processors to perform operations comprising:
identifying a first contact identifier displayed in an image captured by the mobile device, wherein the first contact identifier is indicative of an individual;
providing, to a plurality of social databases including user profile data for a plurality of social networks, respective requests that include the first contact identifier, wherein each request is a query for a user profile associated with the first contact identifier on a social network in the plurality of social networks;
receiving, from a first social database in the plurality of social databases, first user information included in a first user profile identified by the first contact identifier on a first social network;
receiving, from a second social database different from the first social database in the plurality of social databases, second user information included in a second user profile identified by the first contact identifier on a second social network, wherein the second user information differs from the first user information;
generating annotation information by combining the first user information and the second user information; and
providing the annotation information for presentation on the mobile device according to an annotation schema, wherein the annotation schema identifies formatting of annotation information, and wherein the provided annotation information includes references to the first social database and the second social database.

10. The mobile device of claim 9, wherein providing the annotation information comprises:
providing the annotation information as an overlay of the image.

11. The mobile device of claim 9, wherein providing the annotation information comprises:
providing the annotation information separately from the image.

12. The mobile device of claim 9, wherein each reference to a social database included in the annotation information is a link to a respective user profile of a social network associated with the social database.

13. The mobile device of claim 9, wherein the operations further comprise:
obtaining a second contact identifier indicative of the individual;
providing, to the plurality of social databases, respective requests that include the second contact identifier, wherein each request is a query for a user profile associated with the second contact identifier; and
receiving, from at least one of the social databases, responses that identify second user profiles.

14. The mobile device of claim 13, wherein the operations further comprise: filtering one or more of the first user profiles that are associated with a different individual than the second user profiles.

15. A non-transitory computer readable media storing computer executable program instructions, the program instructions including instructions executable to cause one or more processors to perform operations comprising:
identifying a first contact identifier displayed in an image captured by a mobile device, wherein the first contact identifier is indicative of an individual;
providing, to a plurality of social databases including user profile data for a plurality of social networks, respective requests that include the first contact identifier, wherein each request is a query for a user profile associated with the first contact identifier on a social network in the plurality of social networks;
receiving, from a first social database in the plurality of social databases, first user information included in a first user profile identified by the first contact identifier on a first social network;
receiving, from a second social database different from the first social database in the plurality of social databases, second user information included in a second user profile identified by the first contact identifier on a second social network, wherein the second user information differs from the first user information;
generating annotation information by combining the first user information and the second user information; and
providing the annotation information for presentation on the mobile device according to an annotation schema, wherein the annotation schema identifies formatting of annotation information, and wherein the provided annotation information includes references to the first social database and the second social database.

16.-18. (canceled)

19. The computer readable media of claim 15, wherein the operations further comprise:
obtaining a second contact identifier indicative of the individual;
providing, to the plurality of social databases, respective requests that include the second contact identifier, wherein each request is a query for a user profile associated with the second contact identifier; and
receiving, from at least one of the social databases, responses that identify second user profiles.

20. The computer readable media of claim 19, wherein the first contact identifier and the second contact identifier are different types of contact identifiers.

21. The computer readable media of claim 19, wherein the operations further comprise:
filtering one or more of the first user profiles that are associated with a different individual than the second user profiles.

22. The computer readable media of claim 15, wherein each reference to a social database included in the annotation information is a link to a respective user profile of a social network associated with the social database.

23. The computer readable media of claim 15, wherein providing the annotation information comprises:
providing the annotation information as an overlay of the image.
